(19) United States
(12) Patent Application Publication
(10) Pub. No.: US 2007/0062047 A1
(43) Pub. Date: Mar. 22, 2007

(54) Razor blades

(76) Inventors: Andrew Zhuk, Acton, MA (US); Neville Sonnenberg, Newton, MA (US)

Correspondence Address: FISH & RICHARDSON P.C., P.O. BOX 1022, MINNEAPOLIS, MN, 55440-1022, US

(21) Appl. No.: 11/231,218

(22) Filed: Sep. 19, 2005

(51) Int. Cl. B26B 21/60

(52) U.S. Cl. 30/346.53; 30/50

(57) ABSTRACT

Razors are provided that include a safety razor blade unit including a guard, a cap, and a blade located between the guard and the cap. The blade includes a first surface comprising a body and a blade edge; and a second surface, wherein the first surface and second surface meet at a tip, and wherein at least a portion of the blade edge of the first surface is coated by a polymer film. Blades for such razors are also provided.

### TECHNICAL FIELD

This invention relates to razor blades, and more particularly, polymer coated razor blades.

### BACKGROUND

Users of wet shaving razors are susceptible to excessive nicking and cutting. There are many possible explanations for this, but one of them is how the razor blade glides over the skin and how the skin bulge in front of the blade edge is managed. Moreover, as the number of razor blades per cartridge increases, the blade drag against the skin can also increase.

It is common for blades for wet shaving to include a thin polymer coating on the blade edge, which can reduce the frictional resistance between the blade edge and the skin and thereby reduce the cutting force of the hair, greatly improving shaving comfort. Such coatings are described, for example, in U.S. Pat. Nos. 5,645,894 and 5,263,256, the entire disclosures of which are incorporated by reference herein. In general, this polymer coating is applied only to the tip of the razor blade (e.g., the last 25-50 μm) as it is sprayed onto an edge of a stack of blades. Accordingly, a significant portion of the razor blade is not covered with the lubricious coating but instead maintains some contact with the skin.

### SUMMARY

In some embodiments, the invention can improve shaving comfort and safety by improving the way the blade and cartridge glides over the skin and providing better management of the skin bulge, thus minimizing number of nicks and cuts experienced by a user.

In one aspect, the invention features a razor blade including a first surface comprising a body and a blade edge, and a second surface, wherein the first surface and second surface meet at a tip, and wherein at least a portion of both the body and the blade edge of the first surface are coated by a polymer film.

The polymer film may be discontinuous, and may be disposed on the first surface in a plurality of elongated strips, wherein the elongated strips extend from the tip to a distal portion of the body. The elongated strips may extend across the width of the body, or across only a portion of the body. The polymer film may be provided in the form of an array of bumps, circles, polygons, or ellipses. The elongated strips may be spaced apart from between about 20 μm to about 500 μm, e.g., from between about 100 μm to about 400 μm, and may have a width from about 100 μm to about 500 μm, e.g., about 20 μm to about 400 μm. At least about 20%, e.g., at least about 40%, of the first surface may be coated with the polymer film. The discontinuous polymer film may have a thickness from about 1 μm to about 1 mm, e.g., from about 5 μm to about 30 μm, preferably about 10 μm to about 20 μm.

The razor blade may further include a coating between the razor blade and the discontinuous polymer film, e.g., of diamond like carbon, chromium or a plurality of different coatings. A plurality of raised features may underlie at least a portion of the polymer film. These raised features may be formed of a material selected from the group consisting of metals, ceramics and glass.

In another aspect, the invention features a razor including a safety razor blade unit including a guard, a cap, and a blade located between the guard and the cap. The blade includes a first surface defining a body and a blade edge; and a second surface, wherein the first surface and second surface meet at a tip, and wherein at least a portion of the blade edge of the first surface is coated by a polymer film.

The invention also features methods of shaving and methods of manufacturing razor blades.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a diagrammatic perspective view of a blade having strips of polymer coating that extend from the tip of the blade to the back edge of the blade.

FIG. 2 is a diagrammatic perspective view of a blade having circles of polymer coating positioned on various portions of the blade.

FIG. 3 is a front view of a razor cartridge having five blades.

Like reference symbols in the various drawings indicate like elements.

### DETAILED DESCRIPTION

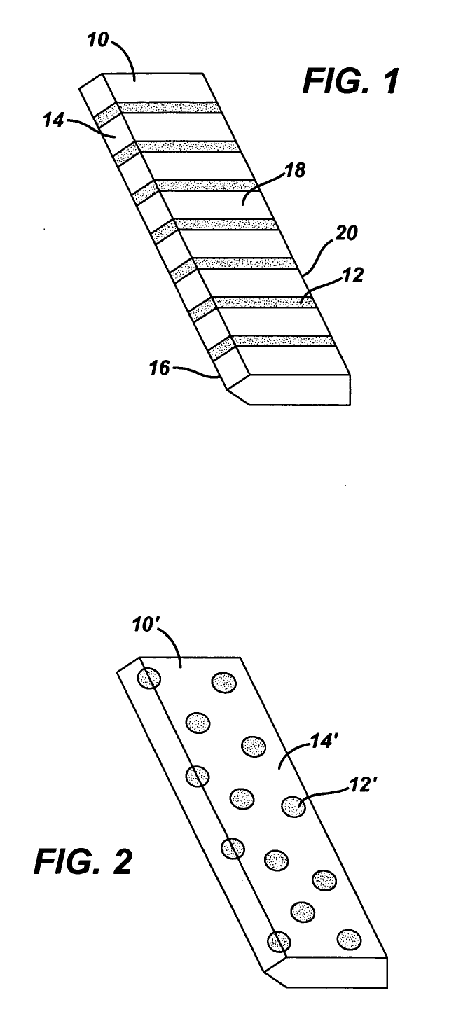

Referring to FIG. 1, a razor blade 10 carries parallel stripes of polymer coating 12 on its upper surface 14. The stripes of polymer coating 12 extend perpendicular to the long edge of the blade, from the blade tip 16 across the flat, non-cutting portion 18 of the blade to the back edge 20. No polymer is coated on the lower surface of the blade. As seen in FIG. 1, the portions of the upper surface 14 of the blade between the strips 12 are entirely free of polymer coating, as is the tip of the blade. In some implementations, the strips 12 may extend further, e.g., to the ultimate tip of the blade, or may be positioned only in the tip area and not on the flat non-cutting portion of the blade.

The parallel stripes of polymer coating 12 provide a height differential between the surface of the polymer coating 12 and the uncoated upper surfaces of the blade, which creates a space that can be used to manage the skin bulge as the blade passes over the skin of a user. This space can help to improve the way the blade, and ultimately a shaving cartridge that includes the blade, glides over the skin of the user, which in turn can reduce the number of nicks and cuts incurred while shaving.

Although the polymer coating on the blade depicted in FIG. 1 is positioned in a series of parallel stripes, other patterns of polymer coating can be used, provided the pattern of the polymer coating allows space for the skin bulge between the surface of the polymer coating and the upper surface of the blade. For example, referring to FIG. 2, the polymer coating 12′ can be configured as a series of circular shapes positioned over the upper surface 14′ of the blade 10′.

Moreover, the patterns for the polymer coating need not be a repeating geometric shape. The polymer coating can be uniform and continuous or it can be spaced at irregular intervals. In some embodiments, the polymer coating can be discontinuous over the flat, skin-contacting surface of the blade.

In some cases, the polymer pattern can be decorative as well as functional, e.g., shaped as a logo or indicia, e.g., the trademark or tradename of the razor distributor. Alternatively, the polymer pattern can be shaped as a flower, a piece of sporting equipment, or any other configuration that provides for spaces in which the skin bulge can be managed between the height of the polymer coating and the upper surface of the blade. If the pattern is intended to be decorative, the decorative elements of the pattern will typically appear on a portion of the upper surface that will be visible to the user when the blade is positioned in a blade unit. The polymer may also be of an aesthetically pleasing color, and the stripes may be of different colors if desired.

In some preferred embodiments, the polymer coating covers from about 20% to about 75% of the upper surface of the blade (e.g., about 30%, about 40%, about 50%, about 60%, or about 70%.) Generally, a sufficient amount of the surface should be covered so as to provide the desired performance characteristics, without increasing the cost of the product to an undesirable extent.

In general, the blade is coated with a polymer coating such as a polyfluorocarbon, e.g., polytetrafluoroethylene (commercially available under the tradename TEFLON). Suitable polyfluorocarbons are discussed, for example, in U.S. Pat. No. 6,228,428, the disclosure of which is incorporated herein by reference.

The chemical nature of the polymer coating can be altered to change the degree of friction desired for passing the razor blade over the skin of a user. For example, a more lubricious polymer coating can decrease the amount of frictional resistance more than a less lubricious polymer. In some instances, the amount of frictional resistance can be altered by selectively changing the thickness of the polymer coating on the tip of the blade, e.g., by using a solvent to remove a portion of the polymer for example as described in U.S. Pat. No. 5,985,459, the full disclosure of which is incorporated herein by reference.

In some instances, the degree of friction of the blade can be altered by the amount of polymer on the upper surface of the blade. For example, if the polymer is configured as depicted in FIG. 1, wider stripes of polymer will create a greater degree of contact between the polymer coating and the skin, thus increasing frictional resistance of the blade. On the other hand, narrower or more highly spaced apart stripes will crease a lesser degree of contact between the polymer coating and the skin, thus decreasing the frictional resistance of the blade. In some preferred embodiments, the stripes have a width of from about 20 μm to about 500 μm (e.g., from about 100 μm to about 400 μm, or about 250 μm). In some preferred embodiments, the stripes are spaced apart by from about 20 μm to about 500 μm (e.g., from about 100 μm to about 400 μm, or about 250 μm). Generally, the spacing between the stripes should be greater than the diameter of an average human hair, i.e., greater than 10 μm for a woman's razor and greater than 100 μm for a man's razor.

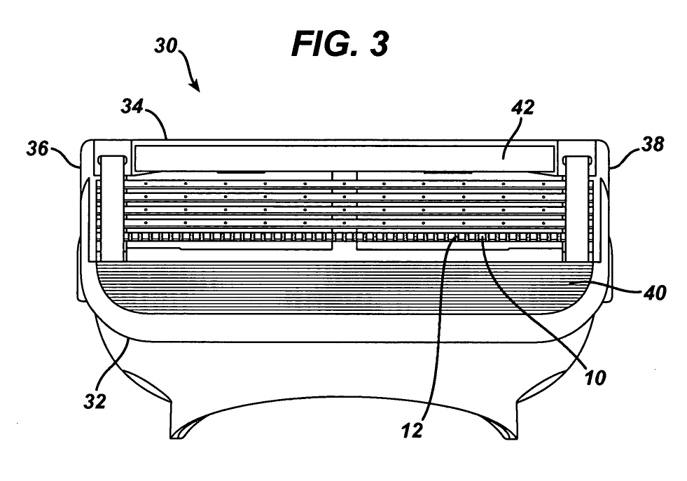

In general, the blade 10 is positioned in a shaving cartridge, for example a blade cartridge that includes a plurality of blades. Referring to FIG. 3, a cartridge 30 having five blades 10 is shown. The cartridge 30 includes a front edge 32, a rear edge 34, and side edges 36 and 38 extending between the front and rear edges 32 and 34. The front edge includes a guard having a plurality of elastomeric fins 40. The rear edge includes a lubricious strip 42. The blade 10 closest to the front edge 32 includes a series of strips of polymer coating 12 as depicted on the blade 10 in FIG. 1.

Although the cartridge 30, depicted in FIG. 3, has only a single blade 10 that includes a polymer coating that extends over the non-cutting portion of the blade as depicted in FIG. 1, in instances where a cartridge includes more than one blade 10, one or more of the blades can include such a polymer coating. For example, in a razor cartridge that includes three blades, the blade closest to the front edge and the blade closest to the rear edge can both include a polymer coating such as the coating depicted in FIG. 1. Alternatively all of the blades can include a polymer coating such as the coating depicted in FIG. 1. In other embodiments, the blade closest to the front edge does not include a polymer coating as depicted in FIG. 1, but instead the blade closest to the rear edge includes a polymer coating such as the coating depicted in FIG. 1.

The positioning of a blade having a polymer coating can be dependent on a number of factors, including the number of blades in the cartridge, the nature of the polymer coating, the degree of polymer coating, and/or the intended use of the razor (e.g., whether the blade will be in a cartridge for a woman's razor or a man's razor). Any number of configurations is possible, provided that at least one blade includes a polymer coating on the cutting portion of the blade. Often, it will desirable to provide a polymer coating on the blade(s) having the highest degree of exposure, to enhance safety and reduce the likelihood of nicks and cuts.

The polymer can be coated onto the blade in a patterned fashion using a mask. The mask is positioned over the entire upper surface of the blade and once positioned a suspension that includes the polymer coating is sprayed over the mask to cover the exposed portions of the blade. The polymer is then sintered to bond it onto the upper surface of the blade. The pattern of open areas of the mask can be selected to obtain a desired pattern of polymer on the blade, and the thickness of the mask can be varied to modify the thickness of the polymer coating.

Other techniques can also be used to apply the polymer coating to the surface of the blade, for example photo or electron lithography using a photoresist, micro-contact or pad printing, or spraying of a dry powder followed by sintering.

A number of embodiments of the invention have been described. Nevertheless, it will be understood that various modifications may be made without departing from the spirit and scope of the invention. Accordingly, other embodiments are within the scope of the following claims.

1. A razor blade comprising;
a first surface comprising a body and a blade edge; and
a second surface, wherein the first surface and second surface meet at a tip, and wherein at least a portion of the blade edge of the first surface is coated by a polymer film.

2. The razor blade of claim 1 wherein the polymer film is a discontinuous film.

3. The razor blade of claim 1 wherein the discontinuous polymer film is disposed on the first surface in a plurality of elongated strips, wherein the elongated strips extend from the tip to a distal portion of the body.

4. The razor blade of claim 3 wherein the elongated strips are spaced apart from between about 20 μm to about 500 μm.

5. (canceled)

6. The razor blade of claim 3 wherein at least some of the elongated strips have a width from about 100 μm to about 500 μm.

7-8. (canceled)

9. The razor blade of claim 2 wherein the elongated strips extend across the width of the body.

10. (canceled)

11. The razor blade of claim 1 wherein at least about 20% of the first surface is coated with the polymer film.

12-14. (canceled)

15. The razor blade of claim 1 wherein the polymer film comprises an array of bumps, circles, polygons, or ellipses.

16. The razor blade of claim 1 wherein at least a portion of the discontinuous polymer film has a thickness from about 1 μm to about 1 mm.

17-18. (canceled)

19. The razor blade of claim 1 wherein the blade comprises metal.

20. The razor blade of claim 1 wherein the blade comprises a ceramic.

21. The razor blade of claim 1 wherein the polymer coating comprises a polyfluorocarbon.

22. The razor blade of claim 21 wherein the polyfluorocarbon is polytetrafluoroethylene.

23. The razor blade of claim 1 further comprising a coating between the razor blade and the discontinuous polymer film.

24. The razor blade of claim 23 wherein the coating comprises diamond like carbon.

25. The razor blade of claim 23 wherein the coating comprises chromium.

26. The razor blade of claim 23 comprising a plurality of coatings.

27. The razor blade of claim 1 further comprising a plurality of raised features underlying at least a portion of the polymer film.

28. The razor blade of claim 27 wherein the raised features are formed of a material selected from the group consisting of metals, ceramics and glass.

29. A razor comprising;
a safety razor blade unit comprising a guard, a cap, and a blade located between the guard and the cap, wherein the blade comprises a first surface comprising a body and a blade edge; and a second surface, wherein the first surface and second surface meet at a tip, and wherein at least a portion of the blade edge of the first surface is coated by a polymer film.

30. The razor of claim 29 further comprising a second blade wherein the blades define parallel edges between the guard and the cap.

31. The razor of claim 30 further comprising a third blade wherein the blades define parallel edges between the guard and the cap.

32. The razor of claim 31 further comprising a fourth blade wherein the blades define parallel edges between the guard and the cap.

33. The razor of claim 29 wherein the polymer film is discontinuous.

34. The razor of claim 33 wherein the polymer film is disposed on the first surface in a plurality of elongated strips.

35. The razor of claim 34 wherein the elongated strips extend from the tip to a distal portion of the body.

36. A method of making a razor blade comprising a first surface having a body and a blade edge, and a second surface, wherein the first surface and second surface meet at a tip, the method comprising disposing a polymer film on the first surface of a razor blade.

37-43. (canceled)
